(19) United States
(12) Patent Application Publication
(10) Pub. No.: US 2010/0208984 A1
(43) Pub. Date: Aug. 19, 2010

(54) EVALUATING RELATED PHRASES

(75) Inventors: Mikhail Bilenko, Bellevue, WA (US); Matthew Richardson, Seattle, WA (US); Sonal Gupta, Austin, TX (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/371,541

(22) Filed: Feb. 13, 2009

(51) Int. Cl. G06K 9/62; G06K 9/68

(52) U.S. Cl. 382/161; 382/218

(57) ABSTRACT

A source keyword may be received multiple times and each time, in response, a machine-learning algorithm may be used to identify and rank respective matching-keywords that have been determined to match the source keyword. A portion or unit of content may be generated based on one of the ranked matching-keywords. The content is transmitted via a network to a client device and a user's impression of the content is recorded. The machine-learning algorithm may continue to rank matching-keywords for arbitrary source keywords while the recorded impressions and corresponding matched-keywords, respectively, are used to train the machine-learning algorithm. The training alters how the machine-learning algorithm ranks matching-keywords determined to match the source keyword.

### BACKGROUND

Broad-matching of keywords has become an important technique used by online advertising platforms, search engines, and other applications that deal with relevancy of keywords. Broad-matching, also referred to as advanced matching, is a process of identifying keywords that are related or similar to a keyword in a context such as a web page or query string. Broad-matched keywords may be used for different applications.

FIG. 1 shows broad-matching for advertising. In the case of advertising platforms, advertisers place bids on keywords. When a bid-for keyword occurs in a search string, for example from a client 100, then a corresponding bidder's ad may be placed with the corresponding search results. A broad-matching algorithm 102 expands the scope of potential ads by mapping the keyword in the query string to one or more similar keywords 104. The expanded or similar keywords 104 may then be used for a variety of purposes, such as ad selection, where an ad of an expanded (broad-matched) keyword may be placed in the search results or elsewhere. An advertising platform may receive the keyword “electric cars”, perform broad-matching to identify matching keywords such as “toyota prius”, “golf carts”, etc. The matching keywords may be ranked by order of relevancy and an ad for a top-matched keyword may be selected. Table 106 shows some examples of matching keywords. Input keywords (keywords in some initial context such as a query string web page) are matched to matching keywords by a broad-matching algorithm such as algorithm 102.

While broad-matching has been used for advertising and other applications, there have been shortcomings in its use. For example, in the realm of online advertising, the keywords that are of interest to users may change rapidly. Current broad-match algorithms cannot keep up with these trends. Estimations of relevancy may quickly become inaccurate. Learning machines for finding and ranking relevant matches may require complete offline retraining when new training data is available. The most effective broad-matching algorithm for a given time or context may not always be used or emphasized. Furthermore, training data may need to be labeled by humans.

Techniques related to keyword broad-matching are discussed below.

### SUMMARY

The following summary is included only to introduce some of the concepts discussed in the Detailed Description below. This summary is not comprehensive and is not intended to delineate the scope of the claimed subject matter, which is set forth by the claims presented at the end.

A source keyword may be received multiple times and in response a machine-learning algorithm may be used to produce or train a ranker that ranks respective matching-keywords that have been determined to match the source keyword. A portion or unit of content may be generated based on one of the ranked matching-keywords. The content is transmitted via a network to a client device and a user's impression of the content is recorded. The machine-learning algorithm may continue to learn about matching-keywords for arbitrary source keywords from recorded impressions (e.g., clickthrough data) and in turn inform or train a ranking component that ranks keywords. The learning alters how the machine-learning algorithm evaluates matching-keywords determined to match the source keyword. It should be noted that “keyword” is used herein in a manner consistent with the meaning it conveys to those of ordinary skill in the art of keyword matching; “keyword” refers to a single word or a short phrase of words that form a semantic unit.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows broad-matching for advertising.

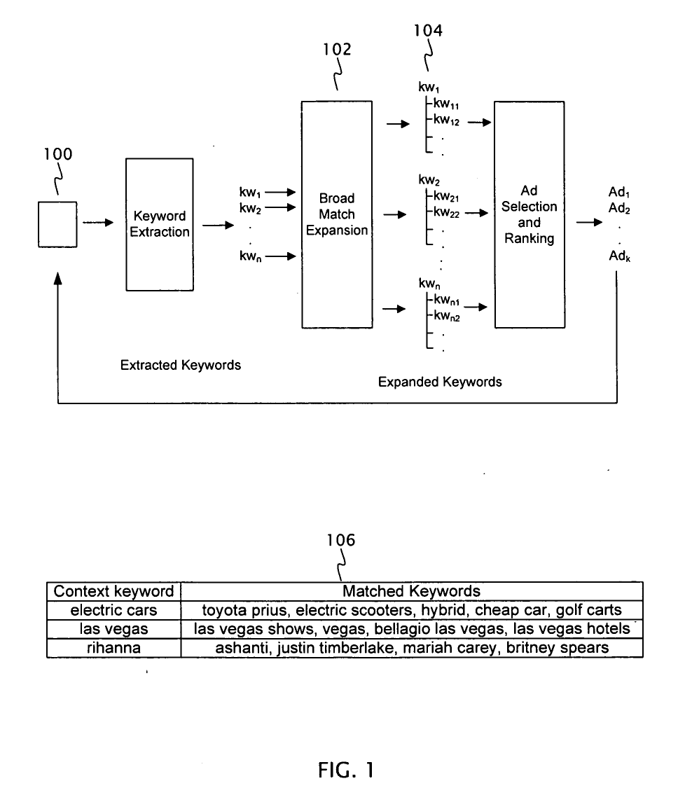

FIG. 2 shows a system using a learning machine.

FIG. 3 shows another system for broad-matching using online learning.

FIG. 4 shows an example of broad-matching keywords.

FIG. 5 shows another example of broad-matching and online training.

FIG. 6 shows an example of a feature extractor.

FIG. 7 shows some example data and features (similarity functions) that may be used.

FIG. 8 shows an example online learning algorithm for broad-matching.

FIG. 9 shows decay rates of samples.

### DETAILED DESCRIPTION

### Overview

Embodiments discussed below relate to a learning-based approach for broad-matching. Learning may be based on implicit feedback (learning samples), which may be user impressions or responses to decisions by a learning machine, for example, advertisement clickthrough logs where ads have been selected based on a decisions by the learning machine. Multiple arbitrary similarity functions (including various existing broad-match algorithms) may be used by incorporating them as features of the learning samples. A learning algorithm may be used to continuously revise a hypothesis for predicting likelihood of user agreement with a match. When user feedback (e.g., click, hover, ignore, etc.) is consistent with a prediction of the hypothesis (e.g., a user clicks an ad selected per a broad-match/expanded keyword as predicted by the hypothesis), then the hypothesis is strengthened. When user feedback is inconsistent with a prediction of the hypothesis, the hypothesis is weakened. In one embodiment, the learning algorithm may reduce the influence of older training data (samples) on the hypothesis, i.e., a sample's impact on the hypothesis may diminish as new samples are obtained.

### Overview of Keyword Matching and Applications

As mentioned above, in the realm of web-based advertising, advertisements may be submitted as bids on specific keywords, where a bid is an amount an advertiser will pay for a user's click on the advertisement. When a bid-for keyword occurs in a delivery context, an advertisement may be selected among candidates based on amounts of bids, degree of relevancy or estimated probability of being clicked, and the like.

### Broad Match Learning Systems

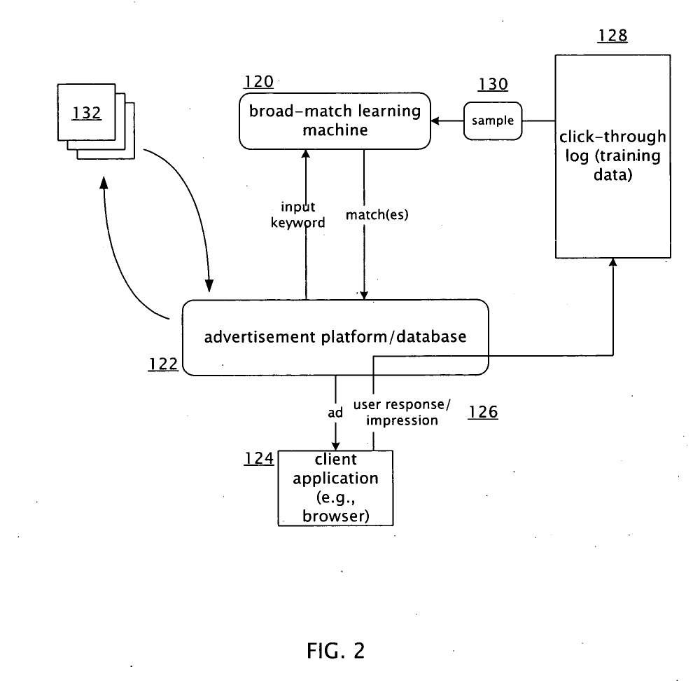

FIG. 2 shows a system using a learning machine 120. The learning machine 120 may receive input keywords. The learning machine 120 may obtain various broad-match keywords (e.g., “laptop”, “Sony”) that have been determined to match a particular input keyword (e.g., “Vaio”). The learning machine 120 may predict which broad-match keywords a user is most likely to treat as similar to the input keyword. The learning machine 120 may do this by applying to the broad-match keywords a current hypothesis (e.g., a vector of weights that may vary over time) about the significance of various features of the broad-match keywords. The broad-match learning machine 120 maintains hypotheses for the keywords, respectively, that it has performed matching analysis on. As discussed below, the broad-match learning machine 120 continually (periodically, but while continuing to operate) revises its hypothesis based on feedback about decisions made by the hypotheses. A hypothesis for a source/input keyword and corresponding broad-match keyword is some information that in effect predicts whether the broad-match keyword, if substituted for the source/input keyword, will be clicked, affirmed, or otherwise treated as similar or related to the source/input keyword. In one embodiment a hypothesis may be used to compute scores or rankings of broad-match keywords. In another embodiment a hypothesis may compute probabilities that broad-match keywords will result in occurrence of a click (or whatever user action is being tracked), and these probabilities may in turn be used for selection, ranking, etc. In general; the learning machine evaluates broad-match keywords based on a current hypothesis and any learning machine that assists in ranking, regardless of the form of its output, may be used.

While learning machine 120 may have many uses (e.g., query replacement, providing a user with a list of candidate synonyms, etc.), in the system of FIG. 2, the learning machine 120 is used in conjunction with an advertisement database or platform 122. The advertisement platform 122 may track various keywords bid on by advertisers and select corresponding advertisements to be displayed in various contexts in which the keywords might occur. Typically, advertisers bid an amount for one or more keywords, and the advertisement platform 122 performs an automated auction to select the highest bidder based on various factors including primarily the amount bid by the advertisers.

To expand the scope of an advertisement and to obviate the need for an advertiser to laboriously maintain a complete and up-to-date set of keywords for an advertising topic, the advertisement platform 122 may use the broad-match learning machine 120 to expand the scope of bid-for keywords. To do so, as indicated by the arrows between the learning machine 120 and the advertisement platform 122, the advertisement may pass a source/input keyword to the broad-match learning machine 120. The broad-match learning machine 120, embodiments of which will be explained in detail further below, receives the input keyword (e.g., “skis”), identifies broad-matching keywords, which are keywords that have been determined, by one or more broad-match algorithms, to be words similar to the input keyword (semantically, and/or textually, etc.). The broad-match learning machine 120 evaluates the broad-match keywords using the learned hypothesis and ranks them according to their various features. In one embodiment, ranking is performed offline and ranked matches are accessed online with lookups. One or more of the top-ranked broad-match keywords are returned or transmitted (e.g., via a network, bus, etc.) to the advertisement platform 122, which then uses the broad-match keywords to select one or more advertisements. Note that the components of system of FIG. 2 are separated and arranged for the purpose of explanation. In practice, the functionality of the components may be arranged in a variety of ways.

The advertisement platform 122 may receive input/source keywords from a variety of sources. In FIG. 2, a client application 124, hosted on a client computer, provides a source keyword, for example, in a search query string or other input. The advertisement platform, possibly after determining that the input keyword should be expanded with broad-matched keywords, passes the input keyword to the broad-match learning machine 120. The broad-match learning machine performs broad matching/ranking on the input keyword. The broad-match learning machine 120 returns one or more top-ranked broad-match keywords to the advertisement platform 122, which uses the returned broad-match keywords to select an advertisement. The selected ad is returned to the client 124, for example in a web page, e-mail, embedded content, RSS feed, etc.

The user of client 124 views and possibly interacts (or declines to interact) with the content or the advertisement. The user's impression 124 (reaction, response, etc.) is captured and logged. In the advertisement example, the user's impression may be recorded in the form of a clickthrough response (i.e., clicking, hovering, etc.), stored in a click-through log 128. Clickthrough may involve a server recording a request for a web page that originated from a known web page, or an advertisement, etc. In either the click-through log 128 and/or a data store used by the broad-match learning machine 120, information is stored that correlates click-through log 128 entries with the corresponding broad-match keyword and input keyword that were used to select the advertisement to which the entry corresponds (i.e., the log entry and the input-match keyword pair are linked or stored together). The click-through log entries and their respective keyword pairs are then used to train the broad-match learning machine 120.

The broad-match learning machine 120 receives a stream of training samples. A sample 130 may include a click-through log entry (a user's impression of or response to an ad) and a corresponding keyword pair (or information for linking to same). The broad-match learning machine 120 uses the user's impression to revise the hypothesis that was used to select or rank the broad-match keyword. Generally, if a user's impression affirms or ratifies the previous determination (reflected in the recorded user impression) of the hypothesis, then the hypothesis is revised or updated to strengthen the predictive likelihood of the broad-match keyword. Conversely, if the user's impression does not affirm or ratify the previous determination, then the hypothesis is revised to reduce the rank of the broad-match keyword relative to other broad-match keywords matching the input/source keyword. Details of how hypotheses may be revised will be described further below.

As mentioned earlier, the broad-match learning machine may continue to operate even while re-learning from incoming samples; the broad-match learning machine may continue to handle keywords for clients 132 while learning/re-training one or more keywords. In other words, the broad-match learning machine may be an online-type of learning machine that can learn from its previous decisions (on-the-fly in some cases). In this document “online learning” refers to the known class of learning algorithms. In one embodiment, a hypothesis of the learning algorithm may include information about the relative contributions of arbitrary “black-box” broad-match algorithms to ranking/predicting the corresponding broad-match keyword's hypothesis.

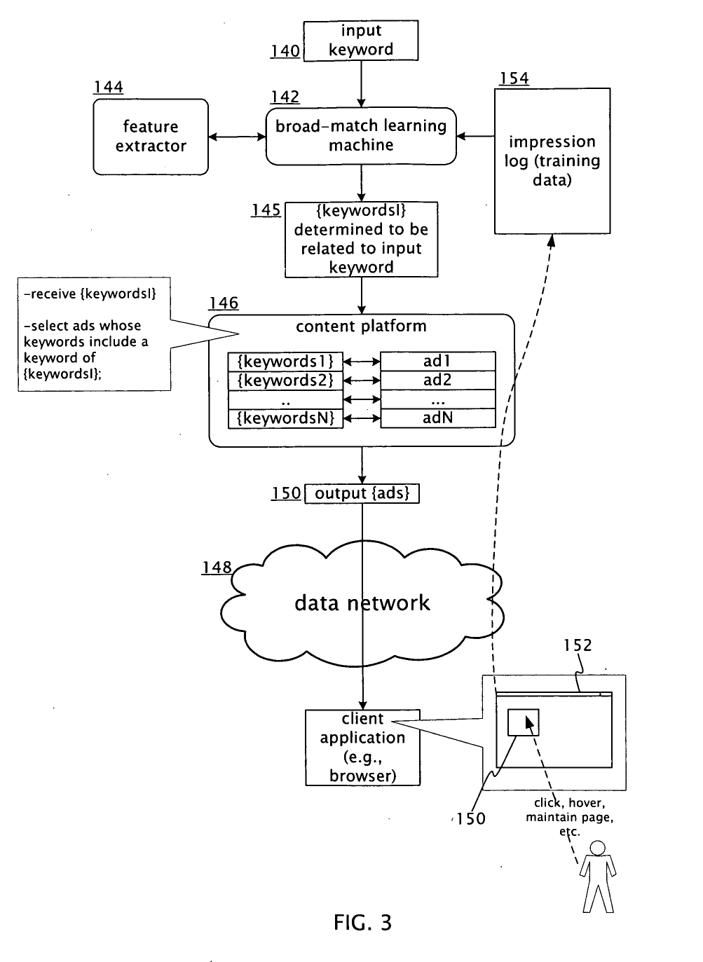

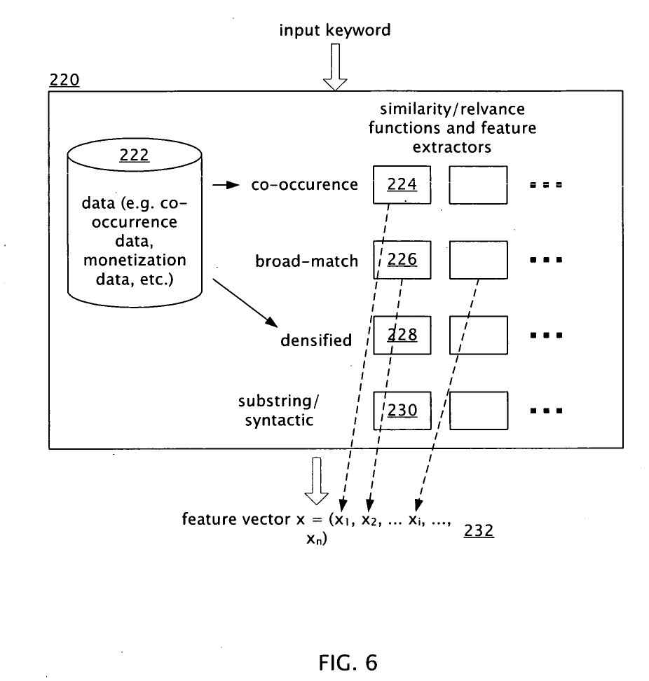

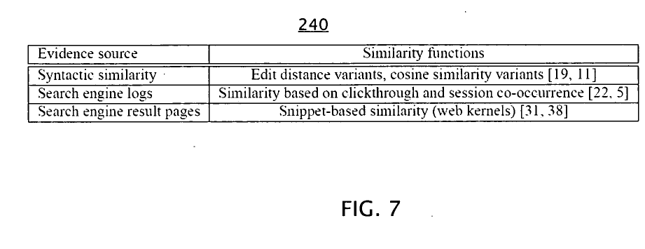

FIG. 3 shows another system for broad-matching using online learning. An input keyword 140 is received by a broad-match learning machine 142. A feature extractor 144 extracts features from the input keyword 140. The features may be based on the input keyword 140 alone, context of the input keyword 140, both, and/or other information (see FIGS. 6 and 7). Furthermore, the feature extraction may include computing matching keywords by a variety of different broad-match algorithms. The broad-match learning machine 142 ranks the keywords that match the input keyword 140 and returns one or more of the top matching keywords 145 to a content platform 146.

The content platform 146 can be any server/service that uses keywords to generate content and provide the content to users via a network 148. For example, in the case of an advertisement platform, keywords are matched to advertisements to select an advertisement. In other embodiments, the content may simply inform a search (i.e., the search category is for products) or the content may be a web page whose subject matter is informed by the received matching keywords 145. The platform 146 transmits output or content 150 thus generated or selected. A client such as an e-mail application or browser 152 receives and displays the content 150 in some visible form such as text, video, an image, etc. The user's reaction or behavior with respect to the displayed content 150 is captured. For example, the user's response may be in the form of an amount of time that the content 150 was displayed, an indication of whether a pointer was hovered over the content, a log of subsequent web pages visited, an answer to a direct inquiry presented through the browser 152 (e.g., “is this the topic of interest to you?”), and so on.

The captured impression is eventually provided to the broad-match learning machine 142, for example in the form of logs 154, data tables, etc. The impression data may be directly transmitted to the broad-match learning machine 142, may be provided via the content platform 146, and so on. In turn, the broad-match learning machine 142 uses the impression log 154 or other form of feedback to learn, that is, it adjusts how it evaluates broad-matching keywords, generally by strengthening the weight of matches that were affirmed by the user, and reducing the weight of matches that were rejected by the user. New samples or impressions may be given greater weight or impact than older samples such that over time, the impact, affect, or influence of prior impressions or samples fades. Details are discussed further below.

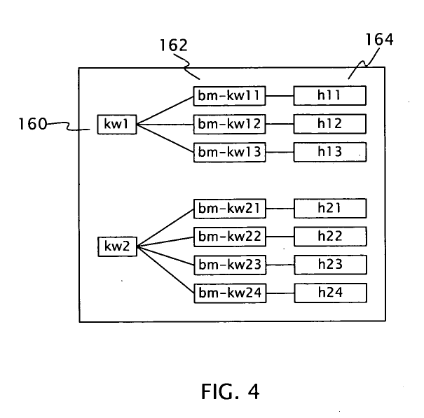

FIG. 4 shows an example of broad-matching keywords. The function of a broad-matching algorithm is to receive an input keyword, e.g. input keyword 160, and rank and/or predict probabilities of related keywords 162 (e.g., semantically similar words, synonyms, alternate spellings, etc). For example, keyword 160 (“kw1”) may have matching keywords 162 “bm-kw11 ” (broad-match keyword 11), “bm-kw12”, and “bm-kw13 ”. The broad-matching algorithm (e.g., an online type of algorithm) may generate estimates or predictions of how likely it is that a user will affirm or agree with (or click) content based on a given matching keyword 162. This may be performed by evaluating the matching keywords using current hypotheses 164 (e.g., “h11”) about how relevant or important are the various features matching keywords.

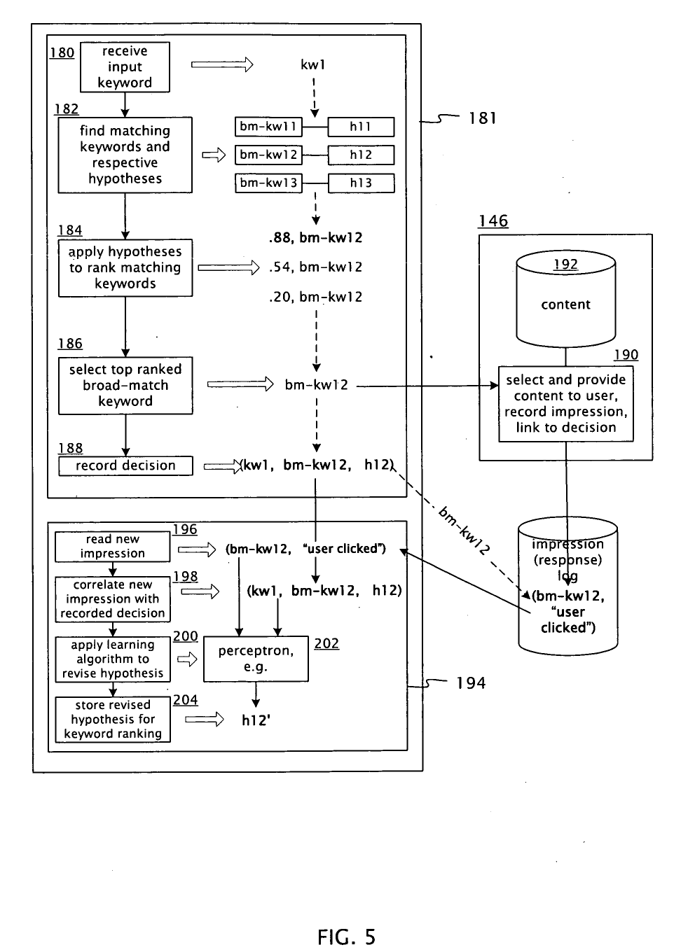

FIG. 5 shows another example of broad-matching and online training. An input keyword is received 180 is received by a matching system 181 (executing on one or more computers). Matching keywords and respective hypotheses are found or selected 182, perhaps by a plurality of independent or integrated keyword matching algorithms. The hypotheses are applied 184 to the matching keywords to generate scores and rank the matching keywords. A top-ranked matching keyword may be selected 186, and a decision of the selection is recorded 188. It may be helpful to store information associating the selection with the particular hypothesis that was applied (as hypotheses may adapt over time in based on feedback). The recorded entry may be in the form of the input keyword (e.g., “kw1”), the selected 186 keyword (e.g., “bm-kw12”), and the hypothesis that was used (e.g., “h12”).

The selected 186 broad-match keyword is passed to a content platform 146 as discussed above. Based on the broad-match keyword, the content platform 146 generates or selects 190 content 192 and provides same to a user, recording the user's impression thereof and facilitating linking of the recorded impression with the recorded decision. For example, the recorded impression may include the broad-match keyword and the user's response thereto (e.g., “user clicked”).

A learning or training component 194 may update the recorded 188 hypothesis using the recorded impression, even while the hypothesis continues to be used or available for servicing other matching requests. The updating may be performed by reading 196 the impression, correlating 198 it with the previously recorded 188 decision, applying 200 a learning algorithm (e.g., a perceptron 202 or other algorithm, described below) to revise the hypothesis, which is then stored 204 and used for future matching for the received 180 input keyword.

As mentioned above, the features extracted or computed for a keyword that is to be broad-matched may include selections or estimations performed by multiple broad-match algorithms. That is, off-the-shelf or other broad-match algorithms, perhaps taking into account different aspects of keywords, such as lexical properties, context, etc. may be used. FIG. 6 shows an example of a feature extractor 220. Data 222 for evaluating keywords may be stored and used by various feature extraction units 224-230. Any types of features may be used and are well described in other sources. FIG. 7 shows some example data and features 240 (similarity functions) that may be used. In the example of FIG. 6, a plurality of broad-match algorithms 226 are used, and each may compute a respective element of an output feature vector 232. Such broad-match algorithms include, but are not limited to, those that use past sequences of user queries on a search engine; those based on similarity of search result snippets obtained by entering a query and a broad-match to a search engine; and those using similarity between category vectors obtained by categorizing the query and the candidate broad-match via a trained classifier. A hypothesis for a keyword may be applied to the feature vector 232 to compute a probability that the keyword will be clicked or interacted with. Alternatively, the hypothesis may be used to compute a score or ranking for the keyword, or may otherwise contribute to selection or ranking of the keyword. In practice, the computed likelihood and hypothesis are “unaware” of the nature of the user feedback mechanism (e.g., click-through logs); what is predicted is the user confirming a keyword via the feedback mechanism, regardless of the type of feedback mechanism used.

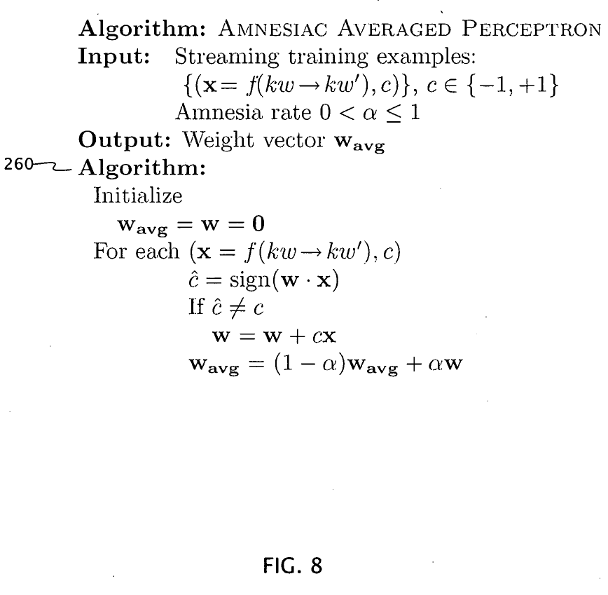

FIG. 8 shows an example online learning algorithm 260 for broad-matching. The learning algorithm 260 can effectively respond to changing conditions that may affect which keywords are currently the best matches. The algorithm 260 modifies the learned hypothesis of a keyword automatically to reflect the drift in underlying distributions and clickthrough data (or other forms of feedback). It should be noted that other online learning algorithms which assume that training instances arrive in a continuous stream may be used, any of which may allow the system to continue learning from clickthrough data (or otherwise) without human intervention, thereby incorporating drift in users', advertisers' and publishers' behavior over time.

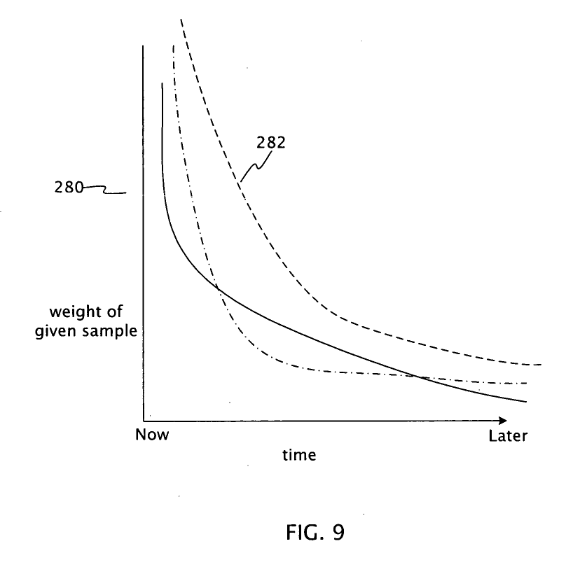

Algorithm 260 is based on a modification of the max-margin voted perceptron algorithm, which is a discriminative online linear classifier described in detail elsewhere. Averaging may be used instead of voting, which may simplify computation. While averaged perceptron is a robust, efficient classifier, it does not immediately account for drift, because its hypothesis is an average of all weight vectors observed in the past. Algorithm 260 modifies an averaged perceptron such that the hypothesis is a multiplicatively re-weighted mean. This effectively corresponds to averaging with an exponential time decay (see FIG. 9, showing different decay rates 282 for different values of α), where the weight vectors (i.e., hypotheses) observed in the past are gradually “forgotten”, while more recent weight vectors have the most influence on the hypothesis.

The result is algorithm 260, which may be called Amnesiac Averaged Perceptron (AAP), processes training examples as a stream, updating a current hypothesis (weights w) when a training example is misclassified by the algorithm (according to user clickthrough feedback, for example), with the update being based on hinge loss. The optimal hypothesis (weights w_{avg}) is maintained as a running average, and is used for actual prediction. Amnesia rate α dictates how much influence recent examples have on the averaged hypothesis compared to past examples. After a certain number of examples, continuous scaling by α will lead to numeric overflow, which may be resolved by periodic scaling of w_{avg}, N and η. Note that notation used in FIG. 8 assumes that each instance vector x=f(kw→kw′) includes a special attribute that always has value 1, which obviates the need for a separate bias term.

A simplified form of algorithm 260 will now be described. Given samples x1, x2, . . . xn, where x1 is the oldest sample and xn is the newest sample, a current weight vector w (hypothesis), at the time of the nth sample, will be equal or proportional to:

$$w = α {\sum }_{i = 1 … n} {( 1 - α )}^{n - i} {w}_{i}$$

where α is the amnesia or decay factor. Other techniques may be used to effectuate decay; the present example is provided as an example of an efficient and simple choice. Other online learning classifiers may be modified for similar effect. The hypothesis is a running statistic in that at the time of any sample xi, the previous samples are reflected in values of the current weights of the hypothesis w; previous samples contribution is reflected in the current w and need not be maintained.

Because the algorithm produces uncalibrated predictions of click (or other feedback, such as hover, protracted display, etc.), a sigmoid calibration may be employed to convert predictions to actual probabilities, which is effective for converting the output of max-margin classifiers to probabilities.

The learning process may be improved by incorporating feature selection. Given a large number of features (see feature vector 232 in FIG. 6) used for classification (broad-matching), redundancy among the features, and the high level of noise inherent in a working data set (a given keyword substitution will sometimes be clicked, and sometimes not), it may be expected that feature selection will improve performance.

Greedy feature selection may be used, based on a holdout set. Greedy feature selection begins with a set of selected features, S (which is initially empty). For each feature fᵢ not yet in S, a model is trained and evaluated using the feature set s ∪ fᵢ. The feature that provides the largest performance gain is added to S, and the process is repeated until no single feature improves performance. Feature selection may be conducted in an online fashion when evaluating the quality of each individual feature.

### Conclusion

Embodiments and features discussed above can be realized in the form of information stored in volatile or non-volatile computer or device readable media. This is deemed to include at least media such as optical storage (e.g., CD-ROM), magnetic media, flash ROM, or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as RAM and/or virtual memory storing information such as CPU instructions during execution of a program carrying out an embodiment, as well as non-volatile media storing information that allows a program or executable to be loaded and executed. The embodiments and features can be performed with the memory and processor(s) of any type of computing device, including portable devices, workstations, servers, mobile wireless devices, and so on.

1. A computer-implemented method for performing broad-match keyword matching, the method being performed by a computing device, the method comprising:
receiving electronic indicia of input keywords and for each input keyword selecting a matching target keyword by:
identifying a plurality of matching keywords that are similar or related to the input keyword;
obtaining a plurality of feature vectors for the matching keywords, respectively, each feature vector having been computed by, for a corresponding matching keyword: computing features of the input and/or matching keyword, the feature vector comprising a plurality of features; and
ranking the target keyword from among the plurality of keywords by using a learning machine to rank the matching keywords based on the feature vectors, wherein the learning machine ranks the matching keywords according to the feature vectors and according to logged indicia of user reactions to prior selections of the matching target keywords; and
transmitting electronic indicia of the selected matching target keywords.

2. A computer-implemented method according to claim 1, further comprising recomputing the learning machine based on a logged indicia of a user reaction to information that was based on a prior selection, by the learning machine, of the matching keyword.

3. A computer-implemented method according to claim 1, wherein the indicia of user reactions to prior selections represent user interaction with a client computer that displayed content that was based on a matching keyword that was selected according to the learning machine, and the learning machine comprises an online learning machine.

4. A computer-implemented method according to claim 1, wherein matching keywords are ranked according to respective machine-computed values, and a value for ranking a matching keyword is computed based on indicia of plural user reactions to plural respective prior selections of the matching target keyword, and wherein the computing is performed such that older prior selections affect the magnitude of the value to a lesser degree than more recent prior selections.

5. A computer-implemented method according to claim 1, wherein the learning machine maintains, for a given input keyword, a current hypothesis that maps features of matching keywords, identified as matching the given input keyword, to respective predictions regarding whether a user will select content that is based on the corresponding matching keyword.

6. A computer-implemented method according to claim 5, wherein the learning machine comprises an online type of learning machine that repeatedly revises the current hypothesis while being available to perform ranking if requested.

7. One or more computer-readable media storing information to enable a computing device to perform a process, the process comprising:
receiving a source keyword multiple times and each time, in response: using a machine-learning algorithm to rank respective matching-keywords that have been determined to match the source keyword, generating a portion of content based on one of the ranked matching-keywords, transmitting the portion of content via a network to a client device, and recording a user's impression of the content; and
while the machine-learning algorithm continues to rank matching-keywords for arbitrary source keywords, using the recorded impressions and corresponding matched-keywords, respectively, to train the machine-learning algorithm, wherein the training alters how the machine-learning algorithm ranks matching-keywords determined to match the source keyword.

8. One or more computer-readable media according to claim 7, wherein, for a given matching-keyword determined to match the source keyword, wherein the using the recorded impressions causes a corresponding given impression to have a decreasing contribution to the ranking as new impressions for the given matching-keyword are used to train the machine-learning algorithm.

9. One or more computer-readable media according to claim 7, wherein the learning-machine comprises an online type of learning-machine that iteratively refines a weight vector hypothesis based on determinations of whether or not the recorded impressions affirm that the corresponding matched-keywords match the source keyword.

10. One or more computer-readable media according to claim 7, wherein the portions of content comprise advertisements selected from a plurality of candidate advertisements.

11. One or more computer-readable media according to claim 7, wherein the recorded impressions comprise click-through data wherein a recorded impression indicates whether a user clicked on the corresponding portion of content.

12. One or more computer-readable media according to claim 7, wherein the learning-machine algorithm comprises a perceptron that uses the recorded impressions as training samples and which gives greater training weight to more recent training samples.

13. One or more computer-readable media according to claim 7, wherein the learning machine ranks a matching-keyword by applying a weight vector to a feature vector of the matching-keyword, the feature vector including outputs of a plurality of respective different broad-match algorithms.

14. One or more computer-readable media according to claim 13, wherein the weight vector for the source keyword changes as the learning-machine is trained with new impressions of matching-keywords of the source keyword, such that, in accordance with the new impressions, some of the broad-match algorithms increase in weight as features and some of the broad-match algorithms decrease in weight as features.

15. A computer-implemented method of training an online-type learning machine, wherein online refers to a particular category of learning algorithm that receives input hypotheses and returns new hypotheses based on samples that test the input hypotheses, the method comprising:
receiving and storing, on a computer, data comprising samples, each sample comprising a recorded user response to a previous output of the learning machine, where each sample is associated with a corresponding broad-match keyword that the learning machine selected as matching an input keyword, and where a sample's corresponding previous output was generated based on the sample's corresponding broad-match keyword; and
training the learning machine with the samples, the training comprising computing a new hypothesis for the input keyword based on the samples, where increasingly older individual samples have decreasing influence on the new hypothesis.

16. A computer-implemented method according to claim 15, wherein the new hypothesis comprises a vector of feature weights and the training comprises re-computing the weights of the new hypothesis based on the samples and based on respective past vectors of feature weights that were used by the learning machine to select the prior broad-match keywords that correspond to the samples.

17. A computer-implemented method according to claim 15, wherein the learning machine comprises an online learning algorithm and the training occurs while the learning machine is servicing requests to select broad-match keywords that match arbitrary input keywords.

18. A computer-implemented method according to claim 15, wherein as time progresses and samples increase in age, some samples influence the hypothesis less or not at all, due to their increased age.

19. A computer-implemented method according to claim 15, wherein the broad-matched keywords comprise keywords bid on by advertising entities and the previous outputs that were based on the broad-matched keywords comprise online advertisements.

20. A computer-implemented method according to claim 19, wherein a recorded user response comprises information indicating whether a user clicked on one of the online advertisements.
